(19) United States
(12) Patent Application Publication
(10) Pub. No.: US 2026/0043206 A1
(43) Pub. Date: Feb. 12, 2026

(54) Material Storage and Spreading System

(71) Applicant: Apply Right, LLC, Belgium, WI (US)

(72) Inventors: Nathan Benjamin Kohn, Eagle River, WI (US); Gregory Paul Stout, Stow, OH (US); Darin Russel Virnig, Sartell, MN (US); James Paul Alishouse, Clear Lake, MN (US); Blake Andrew Tchida, Sartell, MN (US)

(21) Appl. No.: 19/232,322

(22) Filed: Jun. 9, 2025

Related U.S. Application Data
(63) Continuation of application No. PCT/US2025/032686, filed on Jun. 6, 2025.
(60) Provisional application No. 63/680,761, filed on Aug. 8, 2024.
(60) Provisional application No. 63/787,192, filed on Apr. 11, 2025.

(51) Int. Cl. E01H 10/00; E01C 19/20

(52) U.S. Cl. CPC E01H 10/007; E01C 2019/2095

(57) ABSTRACT

A granular material spreading system is provided. The granular material spreading system includes a spreading frame and a tote. The tote is configured to receive a granular, spreadable material and includes an opening allowing the granular material to exit the tote. The tote exit opening is opened by the spreading frame during spreading. When the spreading frame is coupled to the spreading machine, the tote is rotatable by the spreading machine between a storage position in which the opening in the tote is facing horizontally toward the spreading machine and a spreading position in which the opening in the tote is facing the ground surface.

### CROSS-REFERENCE TO RELATED PATENT APPLICATIONS

The present application is a continuation of International Application No. PCT/US2025/032686, filed Jun. 6, 2025, which claims the benefit of and priority to U.S. Provisional Application No. 63/787,192 filed on Apr. 11, 2025, and to U.S. Provisional Application No. 63/680,761 filed on Aug. 8, 2024, which are incorporated herein by reference in their entireties.

### BACKGROUND OF THE INVENTION

The present invention relates generally to a material storage and spreading system. The present invention relates specifically to a storage and spreading system for spreading granular materials (i.e., grit, rock salt, sand, etc.), such as de-icing materials (i.e., salt, ice melt, salt compounds, etc.).

In general, a distribution vehicle, such as a salt truck is used to spread granular materials and/or de-icing materials on various surfaces (roads, parking lots, walkways, etc.) because the de-icing material reduces the melting temperature of snow and/or ice while other granular materials may increase friction on the various surfaces for vehicles, pedestrians, etc.

The granular materials are typically stored in centralized locations forcing the distribution vehicle to travel through snow and ice to retrieve the granular materials. The present invention relates to a spreading device or system intended to be located on-site (i.e., near road, parking lot, sidewalk) eliminating the time and costs associated with the distribution vehicle. Instead, the spreading device or system can be used with an on-site loading machine (i.e., skid loader, forklift, etc.).

### SUMMARY OF THE INVENTION

One embodiment of the invention relates to a granular material spreading system including a tote and spreading frame. The tote includes a housing that has walls, a cavity enclosed by the walls, and an opening extending through one of the walls and connecting to the cavity. The tote further includes a cover coupled to the housing. The cover is moveable between a closed position in which the cover blocks the opening and an open position in which the opening is unblocked by the cover. The cover includes a plurality of flaps. The spreading frame is configured to engage with and support the tote. The spreading frame includes a body, an upper support arm coupled to and extending outward from the body, and a lower support arm coupled to and extending outward from the body. The lower support arm is spaced a distance from the upper support arm such that a gap is defined between the upper support arm and the lower support arm. The spreading frame further includes a finger coupled to and extending outward from the body, the finger is positioned between the upper support arm and the lower support arm. When the spreading frame is disengaged from the tote, the cover releases energy to provide a closing force such that the cover is moved toward the closed position blocking the opening.

When the spreading frame is engaged with the tote, the tote is positioned in the gap between the upper support arm and the lower support arm. The finger presses against the cover of the tote providing a force on the cover such that the cover is pushed away from the opening to the open position such that the opening is unblocked by the cover.

In a specific embodiment, the spreading system further includes a spreading vehicle. The spreading frame is coupled to the spreading vehicle. When the spreading frame is coupled to the tote, the tote is rotatable by the spreading vehicle between a storage position in which the opening in the tote is facing horizontally toward the spreading vehicle and a spreading position in which the opening in the tote is facing the ground surface.

Another embodiment of the invention relates to a spreading frame. The spreading frame is configured to engage with a spreading vehicle and a tote carrying a granular, spreadable material. The spreading frame includes a body, an upper support arm, and a lower support arm. The body includes a forward-facing surface. The upper support arm is coupled to and extends outward from the body. The lower support arm is coupled to and extends outward from the body. The spreading frame further includes a finger and an auger. The finger is coupled to and extends outward from the forward-facing surface of the body. The finger is positioned between the upper support arm and the lower support arm. The auger is coupled to the body and extends outward from the body in a generally parallel orientation to the finger. The finger surrounds the auger.

Another embodiment of the invention relates to storage tote for a granular, spreadable material. The storage tote includes a housing with walls including a side wall, a cavity enclosed by the walls and an opening extending through the side wall and connecting to the cavity. The storage tote further includes a cover coupled to the housing. The cover includes a plurality of flaps. The cover is moveable between a first position in which the cover is positioned along the side wall of the housing such that the opening is covered and a second position in which the cover is positioned away from the side wall of the housing such that the opening is uncovered.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side view of a granular material spreading system with a storage tote disengaged from a spreading frame and a spreading vehicle, according to an exemplary embodiment.

FIG. 2 is a side view of the granular material spreading system of FIG. 1, with the spreading frame and spreading vehicle engaged with the tote in a first, storage position, according to an exemplary embodiment.

FIG. 3 is a side view of the granular material spreading system of FIG. 2, with the tote in a second, spreading position, according to an exemplary embodiment.

FIG. 4 is a perspective view of the spreading frame, according to an exemplary embodiment.

FIG. 5 is a rear perspective view of the spreading frame engaged with the tote, according to an exemplary embodiment.

FIG. 6 is a perspective view of the spreading frame engaged with the tote in the spreading position, according to an exemplary embodiment.

FIG. 7 is a bottom perspective view of the spreading frame engaged with the tote in the spreading position, according to an exemplary embodiment.

FIG. 8 is a cross-sectional view of the spreading frame engaged with the storage tote in the storage position taken along line 8-8 of FIG. 5, according to an exemplary embodiment.

FIG. 9 is a detailed cross-sectional view of the spreading frame engaged with the storage tote, according to an exemplary embodiment.

FIG. 10 is a detailed perspective view of the spreading frame engaged with the tote, according to an exemplary embodiment.

FIG. 11 is a cross-sectional view of the spreading frame engaged with the storage tote in the storage position taken along line 11-11 of FIG. 5, according to an exemplary embodiment.

FIG. 12 is a front perspective view of the tote, according to an exemplary embodiment.

FIG. 13 is a front perspective view from above of the tote of FIG. 12, according to an exemplary embodiment.

FIG. 14 is a front plan view of the tote of FIG. 12, according to an exemplary embodiment.

FIG. 15 is a rear plan view of the tote of FIG. 12, according to an exemplary embodiment.

FIG. 16 is a left plan view of the tote of FIG. 12, according to an exemplary embodiment.

FIG. 17 is a top plan view of the tote of FIG. 12, according to an exemplary embodiment.

FIG. 18 is a bottom plan view of the tote of FIG. 12, according to an exemplary embodiment.

FIG. 19 is a bottom perspective view of the tote of FIG. 12, according to an exemplary embodiment.

FIG. 20 is a front perspective view of the tote of FIG. 12 with a lid open and filled with a granular spreading material, according to an exemplary embodiment.

FIG. 21 is a top perspective view of the tote of FIG. 12 with the lid open, according to an exemplary embodiment.

FIG. 22 is a top plan view of the tote of FIG. 12 with the lid open, according to an exemplary embodiment.

FIG. 23 is a front perspective view of the tote of FIG. 12, according to an exemplary embodiment.

FIG. 24 is a front perspective view of a storage system including stacked totes, according to an exemplary embodiment.

### DETAILED DESCRIPTION

Referring generally to the figures, various embodiments of a storage and spreading device and/or system shown as a granular spreading system are provided. Various embodiments of the storage spreading device and/or system discussed herein include are configured to be located on site (i.e., near road, parking lot, sidewalk) to eliminate the time, costs, and safety hazards associated with using a distribution vehicle (i.e., salt truck). As will be generally understood, distributions vehicles typically retrieve granular materials (i.e., grit, rock salt, sand, etc.), such as de-icing materials (i.e., grit, rock salt, sand, etc.) from a centralized location during a weather event (i.e., snow, ice storm, etc.) before traveling out to deliver the granular materials.

In various embodiments, the granular material spreading system includes a loading machine, a spreading frame, and a storage container. The storage container is designed to provide improved protection to the granular materials stored within the storage container by use of a cover. In contrast to the storage container discussed herein, storage containers may have insufficient protection (i.e., susceptible to leaks, allow entry of moisture, etc.) for granular materials stored on site.

Applicant believes use of flaps over the exit opening or outlet of the container when the container is being used for storage reduces the likelihood of damage (water damage, freezing and/or clumping together, etc.) to the granular materials while allowing for easy and efficient spreading of the material. In various embodiments, the flaps are triangular or pie shaped flaps. In various specific embodiments, the flaps are grommeted to the container. Various embodiments discussed herein relate to a storage container with an exit opening located in a side wall of the container. When the container is being used for storage, the flaps are positioned to block the exit opening of the container. When a user is ready to use the container for spreading the granular material, engagement between the spreading frame and container pushes the flaps to a position away from the exit opening, so the opening is unblocked by the flaps. In various embodiments, the flaps are formed from an elastomeric material such as rubber.

In various embodiments, the interior of the container is shaped to improve the flow of granular material out of the container when the container is in the spreading position. In various embodiments, the portion of the container adjacent or in front of the exit opening is narrowed relative to the remainder of the storage cavity. In various embodiments, the portion of the container in front of the exit opening(s) has a generally frustoconical shape.

Additionally, the design of the spreading frame discussed herein provides for efficient opening of the container and/or flaps during engagement between the spreading frame and the container at the time the user intends to use the system to spread the material. In various embodiments, the frame includes a finger or an opener extending from the frame to push open the flaps when the frame is engaged with the container. In various specific embodiments, the opener is a pipe. In such embodiments, the pipe opens the flaps and acts as a channel or funnel for the granular material leaving the container. In various embodiments, the opener is positioned around the agitator. For example, when the opener is a pipe and the agitator is an auger, the pipe and auger extend from the spreading frame with the pipe surrounding the auger.

In various embodiments, the storage container includes a single lid. Applicant believes use of the single lid reduces the likelihood of granular materials leaking from the container when the container is moved into the spreading position. Further, in various embodiments, the lid includes a lip or ledge extending from the interior surface to block granular material from moving into any space between the lid and body of the container. In various embodiments, the lid is shaped to include a cavity providing additional clearance from the agitator or agitating system (auger, chain, etc.). In various embodiments, the spreading system includes bungees and/or latches on the outside of the container to keep the lid in a tightly closed position when the container is rotated into the spreading position.

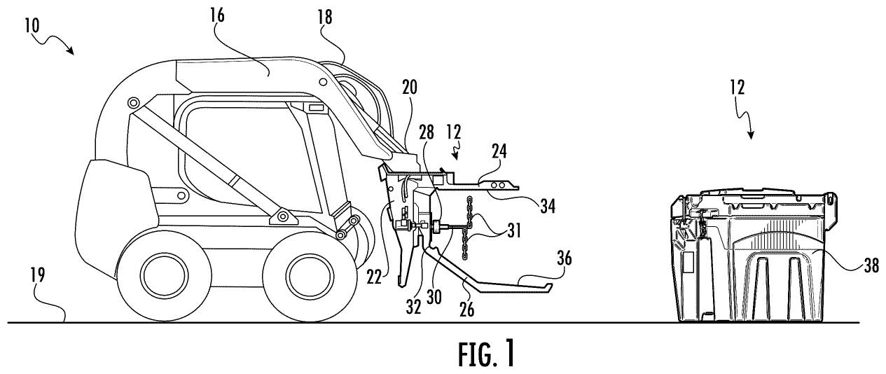

Referring to FIGS. 1-3, various aspects of a storage and spreading device and/or system, shown as a granular material spreading system 10 are shown. In general, granular material spreading system includes a spreading machine 16, a frame shown as a spreading frame 12, and a container, shown as a tote 14. Spreading machine or vehicle 16 is a loading machine (i.e., skid loader, forklift, tractor, etc.). Spreading machine 16 includes a loading arm or boom to move the spreading frame 12 and/or tote 14. In a specific embodiment, spreading machine 16 is powered by a hydraulic system and includes hydraulic lines 18. Hydraulic lines 18 can be connected to spreading frame 12 and/or tote 14 to power components of spreading frame 12 and/or tote 14.

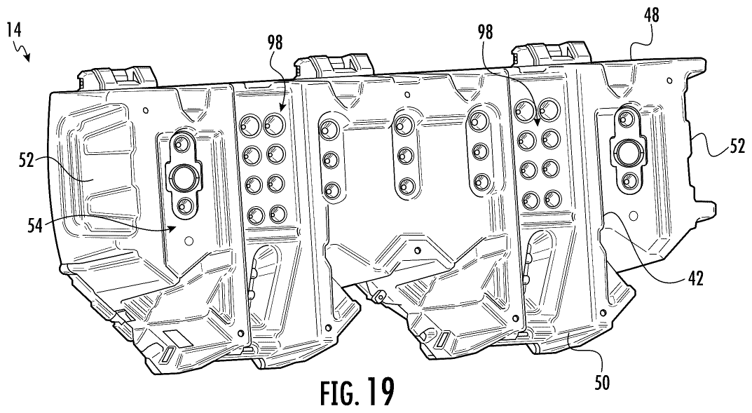

Tote 14 is configured to store granular materials 102 (i.e., grit, rock salt, sand, etc., see e.g., 102 in FIG. 19), such as de-icing materials (i.e., salt, ice melt, salt compounds, etc.) at on-site locations near or at desired spreading areas (i.e., roads, parking lots, sidewalks, etc.).

Specifically, a housing 38 of tote 14 stores the granular materials 102. As will be discussed in greater detail below, housing 38 includes a plurality of walls such as top wall 40, bottom wall 42, front wall 50, rear wall 48 and side walls 52. In various specific embodiments, the granular material 102 is an ice melt or ice melting material. In such an embodiment, the ice melt material reduces the melting temperature of snow and/or ice to facilitate the melting of snow or ice on spreading areas.

Spreading frame 12 is coupled to spreading machine 16 by a vehicle coupling interface 20 that connects the spreading frame 12 to spreading vehicle 16. Spreading frame 12 is configured to engage with and support the tote 14 during the process of spreading the granular material 102 at the desired spreading areas. Spreading frame 12 includes a body 22 with an upper support arm 24 and a lower support arm 26. In various specific embodiments, spreading frame 12 includes a pair of upper support arms 24 and a pair of lower support arms 26. Upper support arm 24 is coupled to and extends outward from body 22. Similarly, lower support arm 26 is coupled to and extends outward from body 22 of spreading frame 12.

As shown in FIG. 1, when the spreading machine 16 is coupled to the spreading frame 12, the spreading machine 16 may be driven to the location where the tote 14 is positioned on a surface shown as ground surface 19, where tote 14 is storing the granular material.

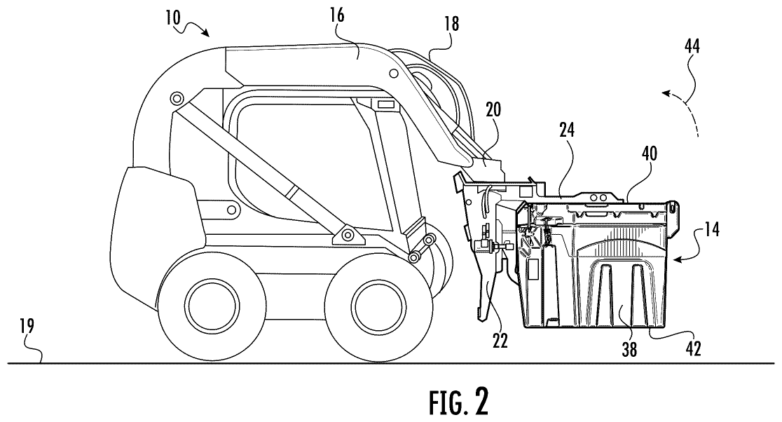

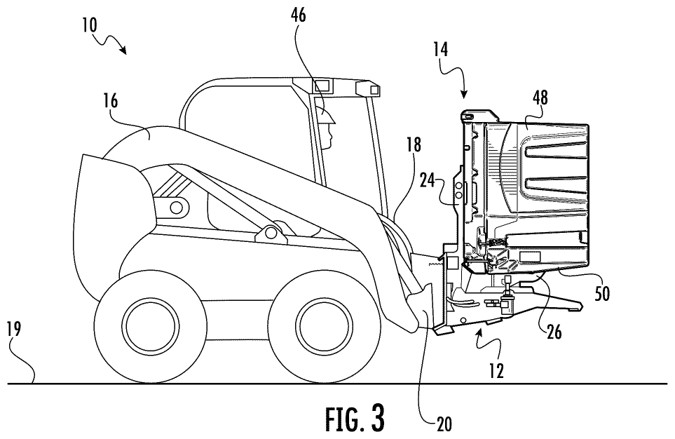

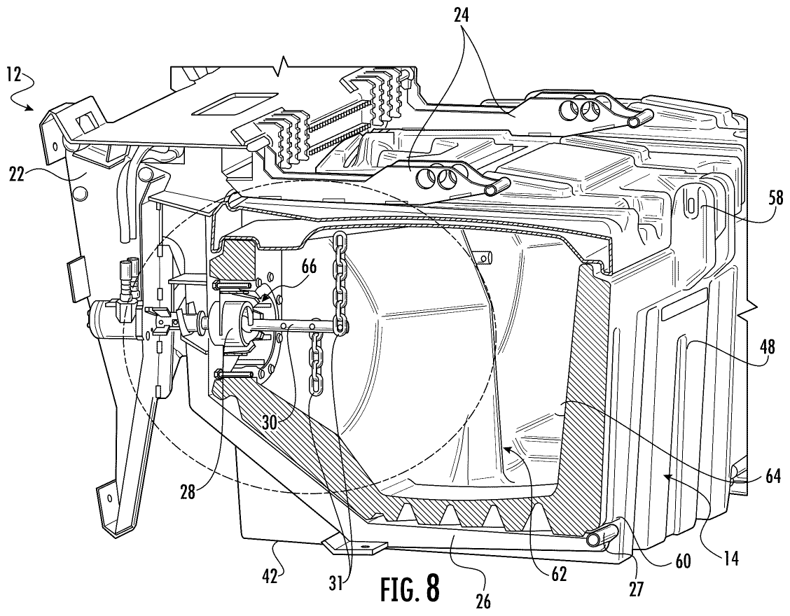

Spreading machine 16 and spreading frame 12 can then pick up and/or engage tote 14 that is in a first, storage position. When tote 14 is in the storage position, top wall 40 is in an upward facing orientation with bottom wall 42 in a downward facing orientation (see e.g., FIG. 2). When an operator 46 of spreading machine 16 has reached a chosen spreading area and wishes to begin spreading the granular material stored within tote 14, the operator 46 can rotate tote 14 in a direction shown by arrow 44, moving tote 14 into a second, spreading position, shown in FIG. 3. In other words, when spreading frame 12 is coupled to spreading machine 16 and when spreading frame 12 is coupled to tote 14, tote 14 is rotatable by the spreading machine 16 between a storage position in which an opening 66 (see e.g., FIG. 8) in the tote 14 is facing in a direction horizontally toward the spreading machine 16 and a spreading position in which the opening 66 in the tote 14 is facing the ground surface 19.

In a specific embodiment, direction 44 is counterclockwise. In other embodiments, tote 14 may be rotated in a counterclockwise direction to move into the spreading position (i.e., if the opening were positioned on what is considered rear wall 48). When tote 14 is in the spreading position, top wall 40 is oriented in a direction facing spreading machine 16 while front wall 50 is facing the ground surface (see e.g., FIG. 3).

Referring to FIG. 3, a side view of tote 14 engaged with spreading frame 12 while tote 14 is in the rotated, spreading position is shown. As previously noted, when tote 14 is in the spreading position, top wall 40 is oriented in a direction facing spreading machine 16 while front wall 50 is facing the ground surface 19. Because a cover, shown as one or more flaps 74 are engaged with spreading frame 12 and in the open position, the granular material 102 stored in cavity 62 can exit through opening 66 to be deposited on the ground surface 19. In other words, when spreading frame 12 is engaged with tote 14 and tote 14 is rotated into the spreading position, the granular material 102 stored within cavity 62 of tote 14 exits through opening 66 and is spreadable onto the ground surface 19.

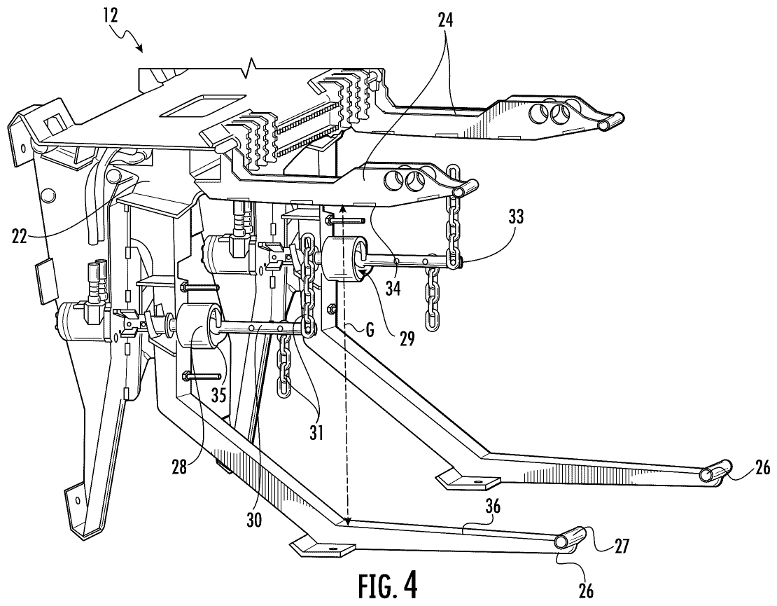

Referring to FIG. 4, details of spreading frame 12 are shown according to an exemplary embodiment. Body 22 includes a forward-facing surface 32 that faces front wall 50 of tote 14 when spreading frame 12 engages with tote 14. Upper support arm 24 includes a lower surface, shown as downward facing surface 34 (e.g., faces lower support arm 26, in the orientation shown in FIG. 4). Lower support arm 26 includes an upper surface, shown as upward facing surface 36 (e.g., faces upper support arm 24, in the orientation shown in FIG. 4). Lower support arm 26 is spaced a distance from upper support arm 24 such that a gap or space exists between lower support arm 26 and upper support arm 24. The gap, G, is sized to receive the housing 38 of tote 14. G is defined between the upper support arm 24 and lower support arm 26. More specifically, G is defined between lower surface 34 of upper support arm 24 and upper surface 36 of lower support arm 26.

Spreading frame 12 further includes a projection, shown as finger 28 that is coupled to and extends outward from body 22. Finger 28 is positioned between upper support arm 24 and lower support arm 26. As will be described in greater detail below, when spreading frame 12 is engaged with tote 14, tote 14 is positioned between upper support arm 24 and lower support arm 26 and finger 28 presses against tote 14 to unblock the exit opening 66 of tote 14. In other words, finger 28 acts as an opener of tote 14. Spreading frame 12 further includes an agitator, shown as auger 30. Auger 30 is coupled to body 22 and extends outward from body 22. In various embodiments, auger 30 extends in the same orientation as finger 28 (e.g., has same longitudinal axis as finger 28 plus or minus 5 degrees). In other words, in specific embodiments, auger 30 is generally parallel to finger 28. In specific embodiments, auger 30 is parallel to finger 28. In specific embodiments, auger 30 and finger 28 are fixed at 90 degrees from body 22. Applicant believes the specific orientations of auger 30 and finger 28 relative to body 20 and relative to each other prevents interference between components. Specifically, if auger 30 were inserted into tote 14 at an undesired angle contact between the auger 30 and tote 14 could result in engagement and damage to tote 14. In various specific embodiments, spreading frame 12 includes a pair of fingers 28 and a pair of augers 30 each extending away from one of the surfaces 32 between upper support arm 24 and lower support arm 26.

In various specific embodiments, finger 28 is a pipe. In such embodiments, the pipe 28 opens the flaps 74 blocking opening 66. In specific embodiments, finger or pipe 28 includes a hollow portion 29 that acts as a channel or funnel for the granular material 102 leaving the tote 14. Applicant believes the hollow portion 29 provides for improved flow of the granular material 102 out of the tote 14. In various specific embodiments, the finger 28 is positioned around or surrounds the auger 30. In a specific embodiment, the finger 28 entirely surrounds the auger 30. In other words, finger 28 surrounds a circumferential perimeter of auger 30 (e.g., finger 28 surrounds auger 30 circumferentially). For example, when the opener is a pipe and the agitator is an auger, the pipe and auger extend from the spreading frame with the pipe surrounding the auger.

Finger 28 extends outward from forward-facing surface 32 of spreading frame 12 a first distance. The first distance is defined as the distance between forward facing surface 32 and a distal end 35 of finger 28. The first distance is chosen to allow for opening of flaps 74. Auger 30 and specifically shaft 68 includes a distal end 33. Auger 30 extends beyond forward-facing surface 32 by a second distance. D2 is defined as the distance between forward-facing surface 32 and distal end 33.

In various specific embodiments, finger 28 extends a first distance, from the forward-facing surface 32 of body 22 and auger 30 extends a second distance, from forward-facing surface 32 of body 22. In a specific embodiment, the first distance is different than the second distance. In a specific embodiment, the first distance is less than the second distance. The greater extension of auger 30 allows for extension into tote 14 to pull material from within tote 14 toward opening(s) 66.

Further, the auger spacing or distance between finger 28 and auger 30 should be a small distance. The auger spacing is small enough that finger 28 opens flaps 74 for auger 30 and also large enough that finger 28 does not engage or interfere with auger 30 and specifically shaft 68 or blade 70. In various specific embodiments, the auger spacing is chosen to prevent interference between auger 30 and finger 28. In various specific embodiments, blade(s) 70 have a dimension less than a dimension of finger 28. In specific embodiments, blade(s) 70 have a dimension less than a diameter of finger 28. Applicant believes such dimensions allow for unrestricted rotation of auger 30 and prevent unwanted flow of granular material 102 when in the spreading position.

In various specific embodiments, a distal end of lower support arm 26 includes a projection 27. Projection 27 engages a portion of bottom wall 42 and acts as stopper (i.e., resists motion to retain tote 14 on lower support arm 26) when tote 14 is engaged with spreading frame 12. Specifically, projection 27 engages with a recessed portion 60 (see e.g., FIG. 8) of bottom wall 42 to resist movement of tote 14 from a position on and/or engaged with lower support arm 26.

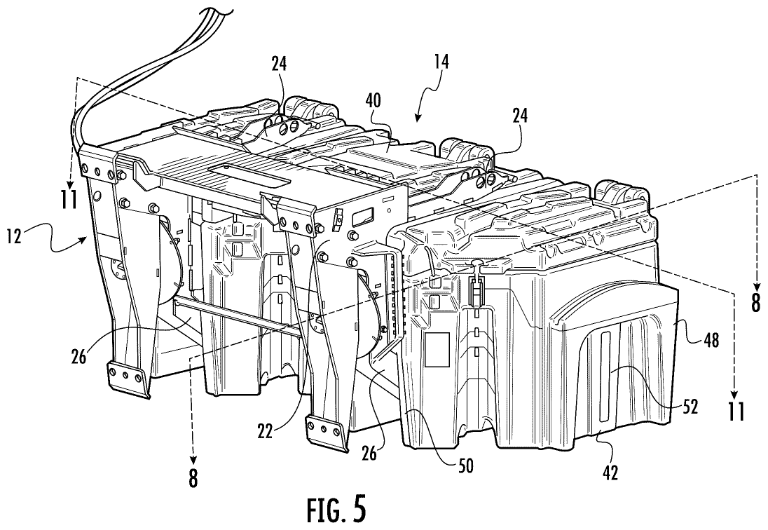

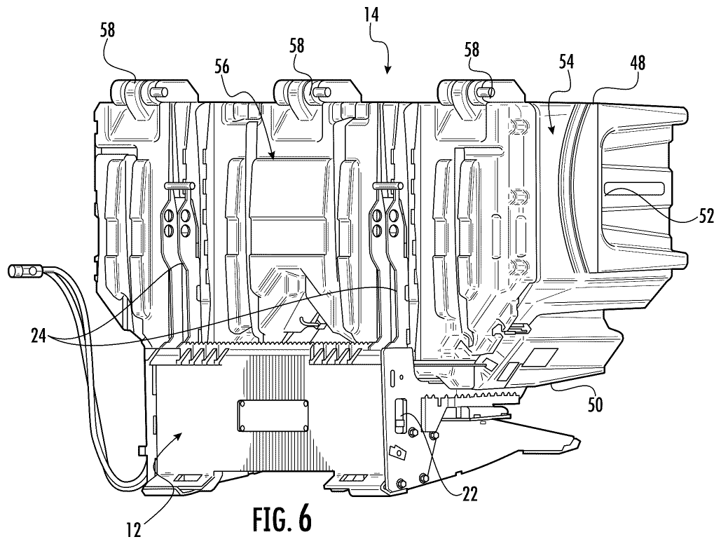

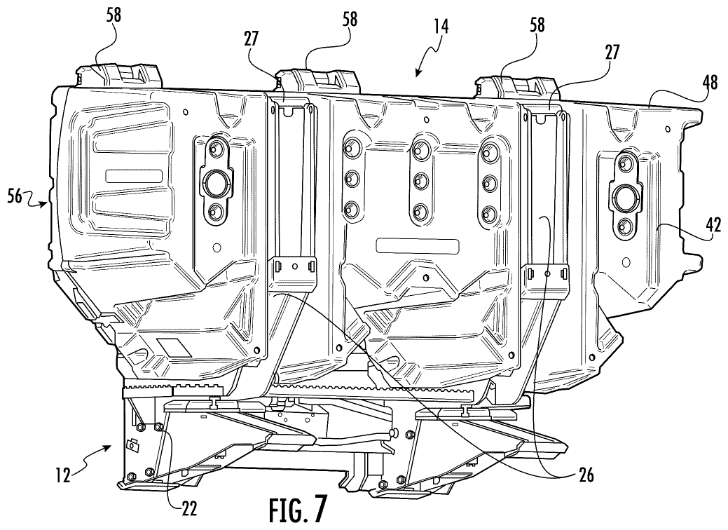

Referring to FIGS. 5-7, views of tote 14 engaged with spreading frame 12 while tote 14 is in the storage position (see e.g., FIG. 5) and a spreading position (see e.g., FIGS. 6-7) are shown. As previously discussed, housing 38 of tote 14 includes a plurality of walls. In various specific embodiments, housing 38 includes a base or lower portion 54 and an upper portion or lid 56. In a specific embodiment, lid 56 is a pivoting lid coupled to and extending between front wall 50 and rear wall 48. In such an embodiment, lid 56 may be coupled to base 54 by a hinge 58.

In various specific embodiments, lid 56 is coupled to base 54 by a plurality of hinges 58. In a specific embodiment, lid 56 is coupled to base 54 by three hinges 58. In other specific embodiments, lid 56 is coupled to base 54 by a different number of hinges 58 (e.g., 2, 4, 5, 6, etc.). In various embodiment, lid 56 is a single, integral lid. Applicant believes use of the single lid 56 reduces the likelihood of granular materials 102 leaking from the tote 14 and specifically from the lid 56 when the tote 14 is moved into the spreading position.

When tote 14 is engaged with spreading frame 12, upper support arm 24 and lower support arm 26 are positioned on opposing sides of housing 38. Specifically, lower support arm 26 extends along and supports bottom wall 42 and upper support arm 24 extends along and/or engages top wall 40 (in the orientation shown in FIG. 5).

As shown in FIG. 8, the engagement between spreading frame 12 and tote 14 includes engagement with the opening, shown as exit opening 66 of tote 14. In various specific embodiments, exit opening 66 extends through front wall 50 of housing 38 and connects to a cavity 62 enclosed by the walls of housing 38. In various specific embodiments, tote 14 includes a pair of openings 66. Cavity 62 is defined by an interior surface 64 of tote 14 and is configured to receive the granular material 102. In other specific embodiments, the exit opening 66 can be placed on another wall of the housing (i.e., rear wall 48, top wall 40, bottom wall 42, etc.).

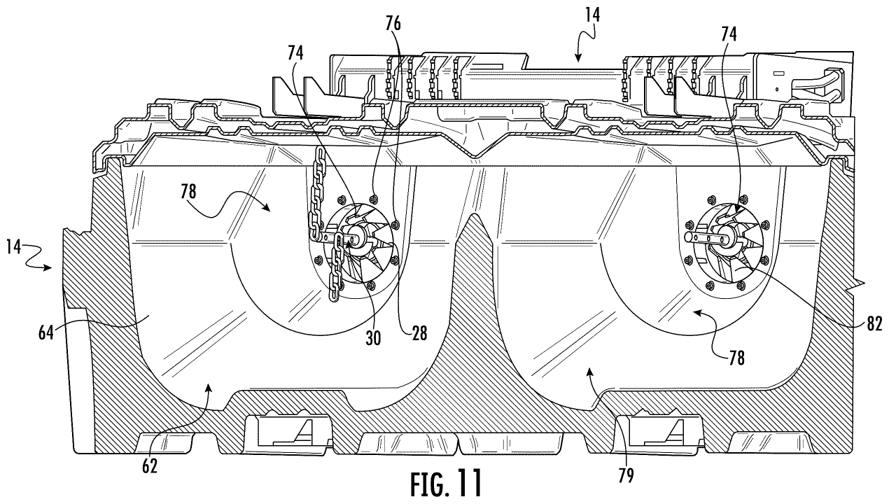

Tote 14 further includes a cover shown as one or more flaps 74 that are coupled to housing 38. In a specific embodiment, flaps 74 are coupled to housing 38 and specifically front wall 50 by grommets 86 (see e.g., FIG. 11). The flaps 74 are moveable between a closed position (see e.g., FIG. 11) in which flaps 74 block or cover opening 66 and an open position in which opening 66 is unblocked by flaps 74.

In various embodiments, the flaps 74 are generally triangular or pie shaped flaps. In various specific embodiments, the flaps 74 are connected (e.g., grommeted) to the tote 14 by grommets 86 (see e.g., FIG. 11). In various embodiments, eight flaps 74 together form a cover for opening 66. In other embodiments, a different number of flaps 74 cover opening 66 (e.g., 6, 10, 12, etc.). In various embodiments, the flaps 74 are formed from an elastomeric material. In a specific embodiment, flaps 74 are formed from rubber.

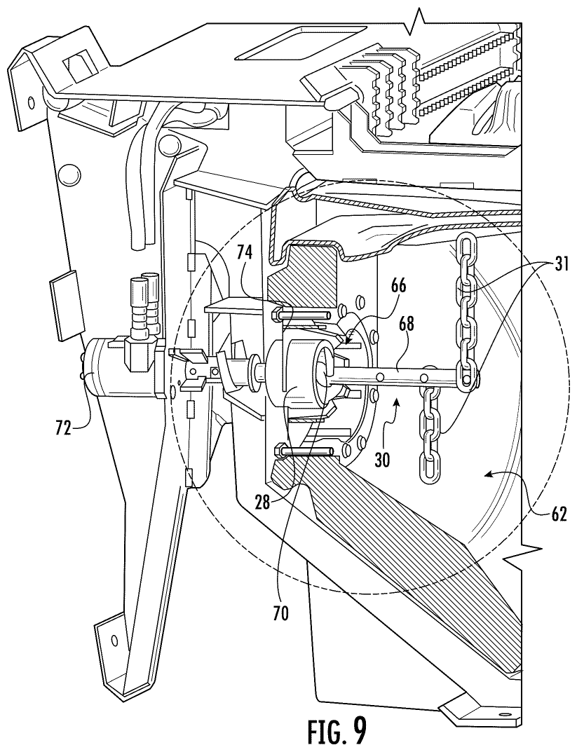

Referring to FIG. 9, a detailed cross-sectional view of tote 14 with flaps 74 in an open position is shown, according to an exemplary embodiment. When tote 14 is disengaged from (i.e., not touching and/or attached to) spreading frame 12, the flaps 74 are in a closed or sealed position. As will be generally understood, elastomeric materials such as flaps 74 store energy through elastic deformation (e.g., when they are stretched energy is stored). When finger 28 disengages from flaps 74, the flaps 74 release the energy providing a closing force such that the flaps return to a resting or closed position.

Flaps 74 further include an inward facing (in the orientation shown in FIG. 9) surface 82. Flaps 74 includes an outward facing surface 80. When flaps 74 are in the closed position, inward facing surface 82 and outward facing surface 80 extend in a generally parallel orientation to interior surface 64 of housing and/or front wall 50.

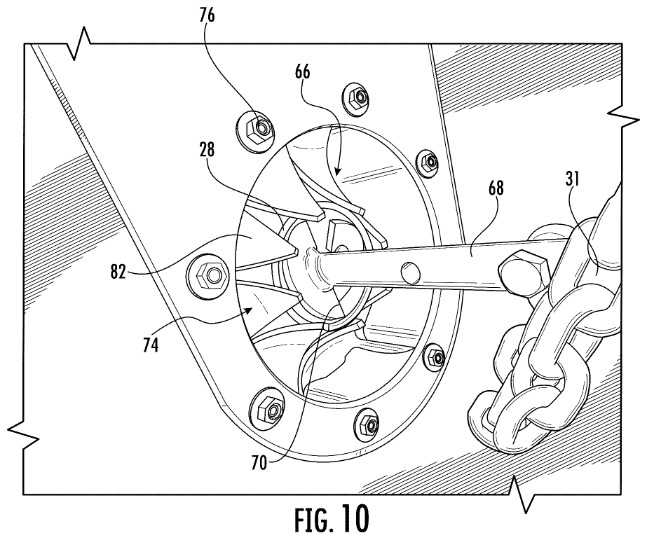

As shown in FIG. 10, as flaps 74 moves into the open position, inward facing surface 82 move toward a position in which inward facing surface 82 are angled toward or facing top wall 40, bottom wall 42, and/or side walls 52 of housing 38. In other words, flaps 74 are pushed inward toward cavity 62 of tote 14. In a closed position, flaps 74 have a first radial extension and a second radial extension in an open position. In specific embodiment, the second radial extension is different than the first radial extension. In specific embodiment, the second radial extension is less than the first radial extension.

At the same time outward facing surface 80 moves into a position where outward facing surface 80 has an angled orientation relative to front wall 50. For example, flaps 74 positioned along an upper portion of opening 66 face bottom wall 42 and flaps 74 positioned along a lower portion of opening 66 face top wall 40 when opened. When flaps 74 are in the open position, the housing 38 is open such that a material positioned within the cavity 62 is removable from housing 38.

When spreading frame 12 is engaged with tote 14, finger 28 presses against and/or engages flaps 74, providing an opening force on flaps 74 such that the flaps 74 are moved away from opening 66 to the open position (see e.g., FIGS. 8-10) such that opening 66 is unblocked by flaps 74. When flaps 74 are in the open position, a material positioned within housing 38 and/or cavity 62 is removable from the housing 38. When finger 28 disengages from flaps 74, flaps 74 release into a position covering opening 66 in the tote (i.e., closed position).

As frame 12 is engaging with tote 14, finger 28 extends through the opening 66 into cavity 62 of housing 38. Similarly, auger 30 and specifically a distal end 33 of auger 30 extends through opening 66 into cavity 62. In various embodiment, auger 30 further includes a rotatable shaft 68 and a blade 70. In a specific embodiment, shaft 68 of auger 30 has a generally cylindrical shape.

In a specific embodiment, one or more agitating components, shown as chains 31 are coupled to auger 30 and specifically shaft 68. In such embodiments, one or more chains 31 are coupled adjacent to distal end 33 of auger 30. In a specific embodiment, each auger 30 includes a top chain 31 and a bottom chain 31. Blade 70 is coupled to and extends at least partially around shaft 68 of auger 30. Applicant believes the blade 70 and one or more chains 31 improve the flow of granular material 102 out of tote 14 by agitating the granular material 102. A proximal end 72 of auger 30 that remains outside of tote 14 even during engagement between spreading frame 12 and tote 14, is configured to be connected to a power source. In other words, a motor of auger 30 can be connected to a power source to drive auger 30.

In a specific embodiment, auger 30 is connected to the hydraulic system of the spreading machine 16 by the hydraulic lines 18. When auger 30 is turned on and/or activated, the shaft 68 rotates about a longitudinal axis of the auger 30. As the shaft 68 of the auger 30 rotates, blade 70 rotates. When cavity 62 is filled with the granular material and flaps 74 are open, the auger 30 and auger blade 70 create a force that moves and/or pulls the granular material toward or through opening 66.

When tote 14 is engaged with (i.e., touching and/or attached to) spreading frame 12, finger 28 provides the opening force on flaps 74 by pressing and/or interfacing against outward facing surface 80 of flaps 74. Such engagement moves the flaps 74 is moved toward the open position shown, where opening 66 is unblocked and/or uncovered. Finger 28 extends through opening 66 in a position that allows finger 28 to hold flaps 74 in the open position.

Referring to FIG. 11, a cross-sectional view taken along line 11-11 of FIG. 5 is shown according to an exemplary embodiment. When frame 12 is coupled to tote 14, each finger 28 opens the flaps 74 that cover each opening 66 of tote 14. In such an embodiment, each auger 30 also extends into tote 14 and/or cavity 62. Flaps 74 are coupled to tote 14 by one or more fasteners 76. In specific embodiments, the fasteners are bolts.

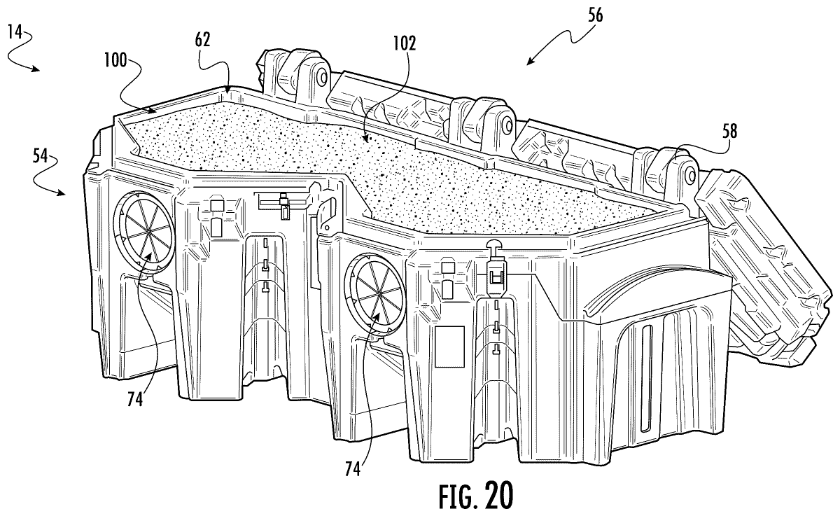

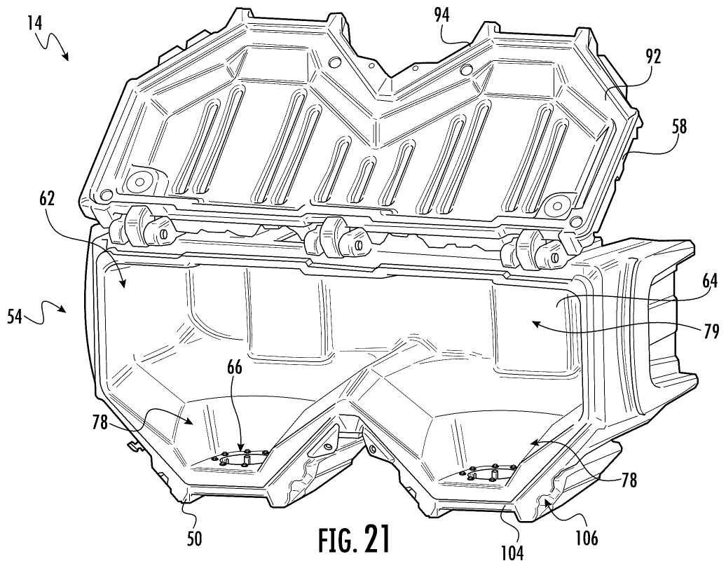

In various specific embodiments, cavity 62 of tote 14 includes one or more portions shaped to improve the flow of granular material 102 (see e.g., FIG. 20) out of tote 14. In specific embodiments, cavity 62 includes a front portion 78 and a main portion 79. Front portion 78 is positioned at a front of the container (e.g., near front wall 50) adjacent to or in front of opening 66. As shown in FIG. 11, front portion 78 is narrowed relative to main portion 79 of cavity 62.

In various specific embodiments, the front portion 78 of the tote 14 in front of the exit opening(s) 66 has a generally frustoconical shape. In other words, Applicant believes the narrowed or funnel shape of front portion 78 improves the flow granular material 102 out of openings 66.

In specific embodiments, cavity 62 includes a first front portion 78 and a second front portion 78 connected to main portion 79. In such an embodiment, there is a front portion 78 positioned adjacent to each opening 66. In specific embodiments, the number of front portions 78 of cavity 62 is the same as the number of exit openings 66.

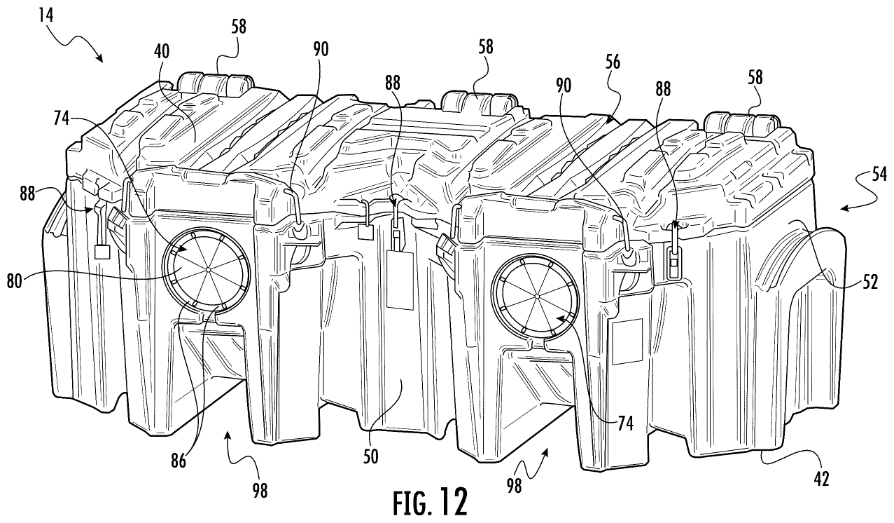

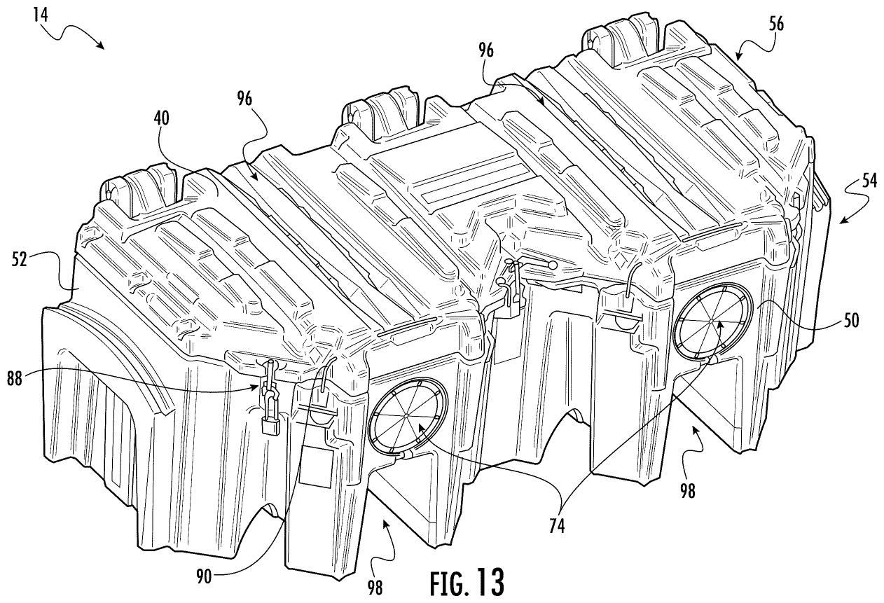

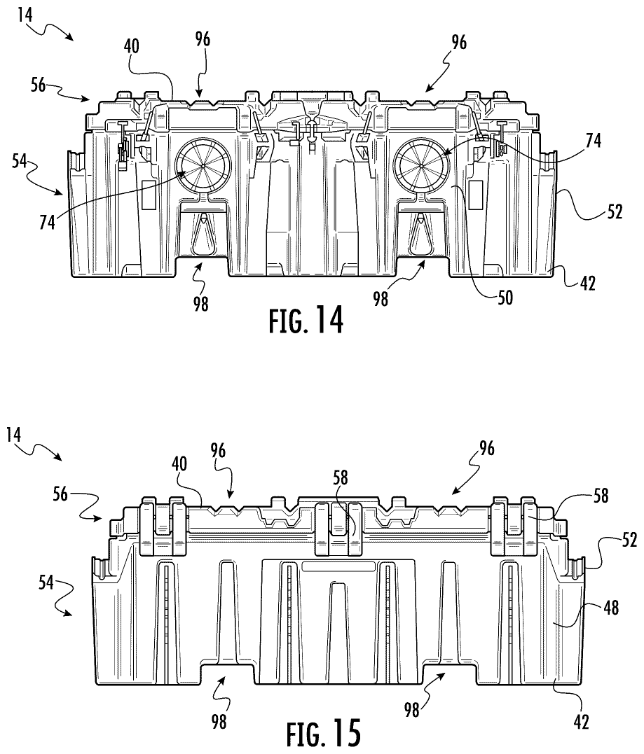

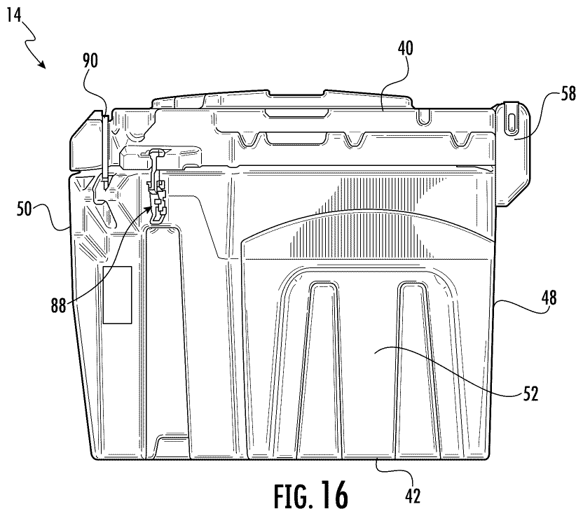

Referring to FIGS. 12-19, various details of tote 14 are shown according to an exemplary embodiment. Tote 14 includes one or more recessed portions 96, 98 that are configured to receive and engage with frame 12 and specifically upper support arms 24 and lower support arms 26 (see e.g., FIGS. 5-7). In specific embodiments, the recessed portions 96, 98 are positioned along a length of tote 14 adjacent to openings 66 and/or flaps 74. In other words, recessed portions 96, 98 are positioned along the length of the tote 14 between side walls 52 and above or below openings 66 and/or flaps 74 respectively (in the orientation shown in FIG. 14).

In various specific embodiments, tote 14 and specifically top wall 40 includes one or more upper recessed portions 96 configured to receive and engage one or more upper support arm(s) 24. In a specific embodiment, top wall 40 includes a pair of upper recessed portions 96 extending between front wall 50 and rear wall 48. In such an embodiment, the pair of upper recessed portions 96 are configured to receive and engage the pair of upper support arms 24.

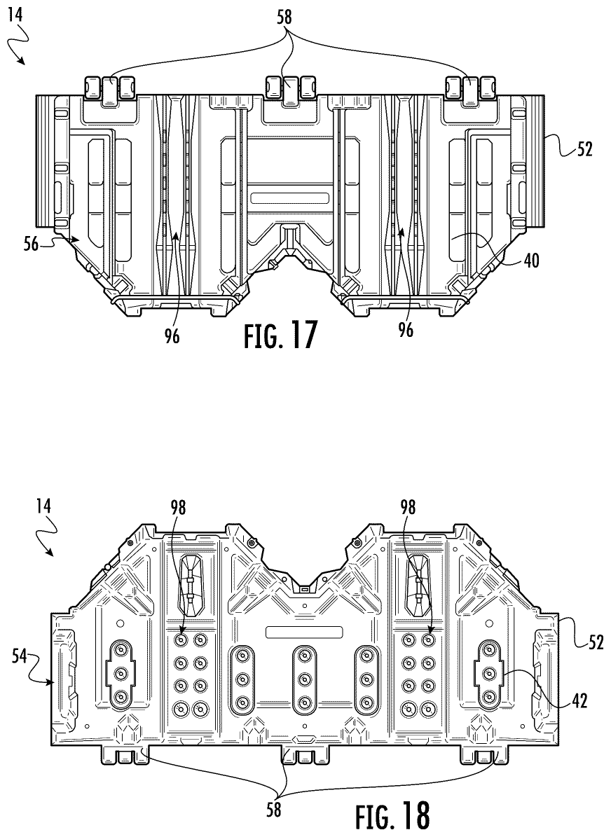

In various specific embodiments, tote 14 and specifically bottom wall 42 includes one or more lower recessed portions 98 configured to receive and engage one or more lower support arm(s) 26. In a specific embodiment, bottom wall 42 includes a pair of lower recessed portions 98 extending between front wall 50 and rear wall 48 (see e.g., FIGS. 18-19). In such an embodiment, the pair of lower recessed portions 98 are configured to receive and engage the pair of lower support arms 26.

As shown in FIGS. 12-14, in various embodiments, the spreading system includes bungees 90 and/or latches 88 on the outside of the tote to ensure the lid 56 is secured in a tightly closed position when tote is rotated into the spreading position. In specific embodiments, tote 14 includes one or more latches 88 positioned along front wall 50 to secure lid 56 to base 54 of tote 14. Applicant believes the use of latches 88 and/or bungees 90 reduces the likelihood of unwanted spilling of granular material 102 out of lid 56 rather than through openings 66.

Referring to FIGS. 20-22, perspective views of tote 14 are shown, according to an exemplary embodiment. In a specific embodiment, lid 56 includes an interior surface 92 that opposes an exterior side. In various embodiments, interior surface 92 of lid 56 is shaped to include a cavity providing additional clearance from the agitator 30 or agitating system (auger, chain 31, etc.). Applicant believes the additional space provided to the agitator 30 and/or agitating system creates improved flow of granular material 102 out of openings and reduces wear and/or damage that might be caused by unwanted engagement or interference between the agitator and base When lid 56 is fully opened (see e.g., FIG. 21), the filling opening 100 of housing 38 is open. The lid 56 extends between front wall 50 and rear wall 48 to cover the filling opening 100 and granular material 102 when granular material 102 has been placed in tote 14 and/or cavity 62 is filled.

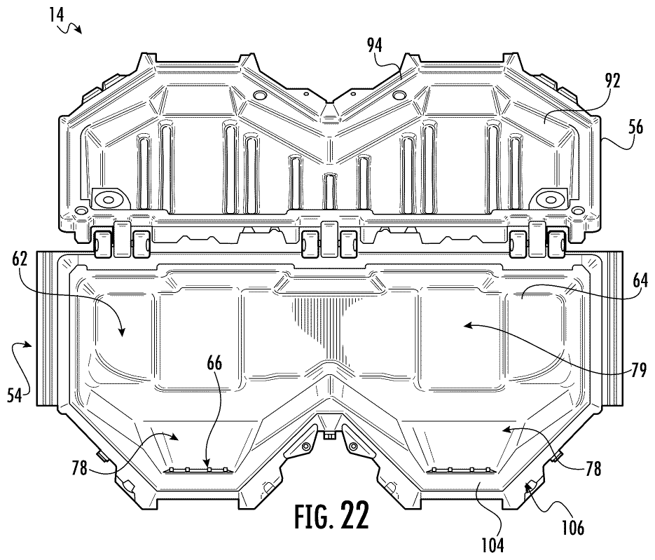

As show in FIGS. 21-22, in various embodiments, the lid 56 includes a ledge or lip 94 extending from the interior surface 92 to block granular material 102 from moving into any space between the lid 56 and base 54 of tote 14. In various embodiments, lip 94 extends around a perimeter of lid 56. Applicant believes the lip 94 further reduces the likelihood of unwanted movement of granular material 102 out of tote 14 in a location beside the opening(s) 66. Base 54 includes a recessed section 106 on a top of base 54. Recessed section 106 is configured to receive and engage lip 94 of lid 56 (see e.g., FIG. 8).

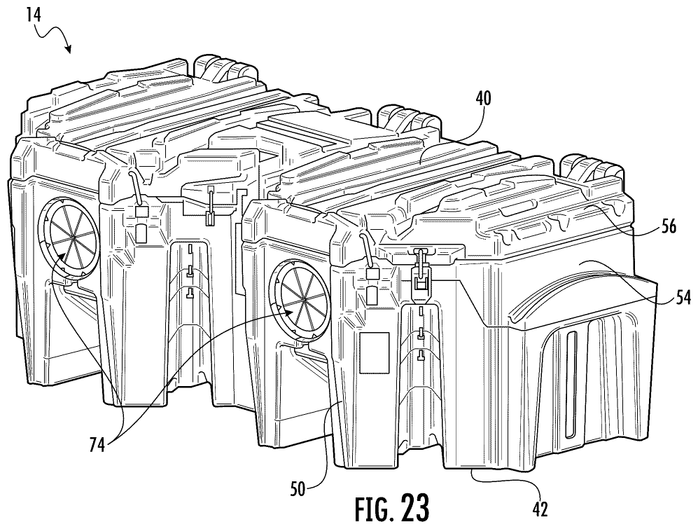

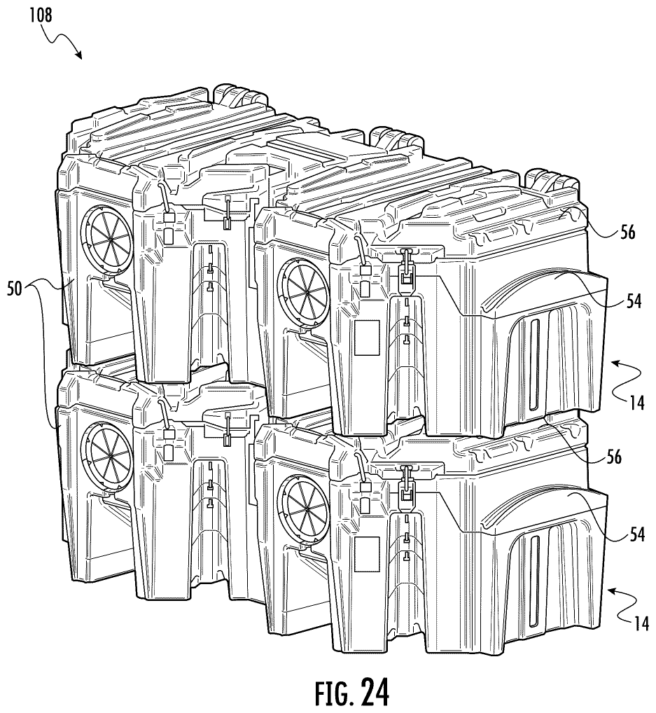

Referring to FIGS. 23-24, modularity of the material spreading system and specifically of totes 14 is shown according to an exemplary embodiment. As shown in FIG. 24, one or more totes 14 can be stacked on top of each other (e.g., coupled together along a vertical axis of each tote 14) to form a tote system 108. In other words, a top wall 40 of one tote 14 is positioned against or engaged with the bottom wall 42 of another tote 14. In this manner, a larger volume of granular material 102 may be stored at specific locations.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A granular material spreading system comprising:
a tote comprising:
a housing comprising:
walls;
a cavity enclosed by the walls; and
an opening extending through one of the walls of the housing and connecting to the cavity;
a cover coupled to the housing such that the cover is moveable between a closed position in which the cover blocks the opening and an open position in which the opening is unblocked by the cover, wherein the cover comprises a plurality of flaps; and
a spreading frame configured to engage with and support the tote, the spreading frame comprising:
a body;
an upper support arm coupled to and extending outward from the body;
a lower support arm coupled to and extending outward from the body, the lower support arm is spaced a distance from the upper support arm such that a gap is defined between the upper support arm and the lower support arm; and
a finger coupled to and extending outward from the body, the finger positioned between the upper support arm and the lower support arm;
wherein, when the spreading frame is disengaged from the tote, the cover releases energy to provides a closing force such that the cover is moved toward the closed position blocking the opening; and
wherein, when the spreading frame is engaged with the tote, the tote is positioned in the gap between the upper support arm and the lower support arm, and the finger presses against the cover of the tote, providing a force on the cover such that the cover is pushed away from the opening to the open position such that the opening is unblocked by the cover.

2. The spreading system of claim 1, further comprising a spreading vehicle and the spreading frame is coupled to the spreading vehicle, wherein, when the spreading frame is coupled to the tote, the tote is rotatable by the spreading vehicle between a storage position in which the opening in the tote is facing in a direction horizontally toward the spreading vehicle and a spreading position in which the opening in the tote is facing a ground surface.

3. The spreading system of claim 2, further comprising a granular material located in the cavity of the tote, wherein, when spreading frame is engaged with the tote and the tote is rotated into the spreading position, the granular material stored within the cavity of the tote exits through the opening and is spreadable onto the ground surface.

4. The spreading system of claim 3, wherein the granular material is an ice melting material.

5. The spreading system of claim 1, the spreading frame further comprising an auger with a rotatable shaft coupled to the body and extending outward from the body in a generally parallel orientation to the finger.

6. The spreading system of claim 5, wherein the auger is positioned within the finger such that the finger surrounds the auger circumferentially.

7. The spreading system of claim 1, wherein the cover is formed from an elastomeric material;
wherein, when the finger engages the cover, the elastomeric cover is deformed such that cover stores energy; and
wherein, when, the finger disengages from the cover, the cover releases energy driving movement of the cover to a position over the opening in the tote.

8. The spreading system of claim 1, wherein the cover is formed from rubber.

9. A spreading frame configured to be engaged with a spreading vehicle and a tote carrying a granular, spreadable material comprising:
a body including a forward-facing surface;
an upper support arm coupled to and extending outward from the body;
a lower support arm coupled to and extending outward from the body;
a finger coupled to and extending outward from the forward-facing surface of the body, the finger positioned between the upper support arm and the lower support arm; and
an auger coupled to the body and extending outward from the body in a generally parallel orientation to the finger, the finger surrounding the auger.

10. The spreading frame of claim 9, wherein the spreading frame is coupled to a vehicle coupling interface that connects the spreading frame to the spreading vehicle.

11. The spreading frame of claim 9, wherein the finger extends a first distance from the forward-facing surface of the body and wherein the auger extends a second distance from the forward-facing surface of the body.

12. The spreading frame of claim 11, wherein the first distance is less than the second distance.

13. The spreading frame of claim 8, wherein the finger comprises a hollow portion, wherein the finger is configured to engage and move a cover on a storage tote and wherein the hollow portion provides a channel to move a granular material out of the storage tote.

14. The spreading frame of claim 8, wherein the finger is a pipe.

15. A storage tote for a granular, spreadable material comprising:
a housing comprising:
walls including a side wall;
a cavity enclosed by the walls; and
an opening extending through the side wall and connecting to the cavity;
a cover coupled to the housing, the cover comprising a plurality of flaps; and
wherein the cover is movable between a first position in which the cover is positioned along the side wall of the housing such that the opening is covered, and a second position in which the cover is positioned away from the side wall of the housing such that the opening is uncovered.

16. The storage tote of claim 15, wherein the cover is formed from an elastomeric material, and wherein the tote further comprises the granular, spreadable material positioned within the cavity.

17. The storage tote of claim 16, wherein the granular, spreadable material is an ice melt material.

18. The storage tote of claim 15, wherein, when the cover is in the second position, the housing is open such that a material positioned within the cavity is removable from the housing.

19. The storage tote of claim 15, wherein the side wall with the opening is a front wall and the walls further include a rear wall.

20. The storage tote of claim 15, wherein the plurality of flaps each have a generally triangular shape.
